(19) United States
(12) Patent Application Publication
(10) Pub. No.: US 2026/0112741 A1
(43) Pub. Date: Apr. 23, 2026

(54) THERMAL MANAGEMENT SYSTEM FOR ELECTRIFIED VEHICLE

(71) Applicant: Ford Global Technologies, LLC, Dearborn, MI (US)

(72) Inventors: Hans Guenter Quix, Herzogenrath (DE); Jan Mehring, Koeln (DE)

(21) Appl. No.: 19/338,036

(22) Filed: Sep. 24, 2025

(30) Foreign Application Priority Data
Oct. 17, 2024 (DE) 102024130125.2

(51) Int. Cl. H01M 10/663; B60L 58/26; B60L 58/27; H01M 10/613; H01M 10/615; H01M 10/625; H01M 10/6568; H01M 10/6569

(52) U.S. Cl. CPC H01M 10/663; B60L 58/26; B60L 58/27; H01M 10/613; H01M 10/615; H01M 10/625; H01M 10/6568; H01M 10/6569

(57) ABSTRACT

A thermal management system for a vehicle may include a primary circuit through which a refrigerant flows, the primary circuit including an evaporator and a condenser. The system may further include a secondary circuit through which a coolant flows. The system may further include a pump to drive the flow of coolant in the secondary circuit. The system may further include a plurality of control valves to regulate the flow of coolant in the secondary circuit, the control valves being activated by a control device to switch flow connections within the secondary circuit. The control valve may include at least one multi-way valve having multiple openings, the connections between the openings established by a slide arranged to rotate within the valve.

### RELATED APPLICATION(S)

This disclosure claims priority to German Patent Application No. 102024130125.2, filed Oct. 17, 2024, the entirety of which is herein incorporated by reference.

### TECHNICAL FIELD

This disclosure relates to a thermal management system for an electrified vehicle and a corresponding method.

### BACKGROUND

The need to reduce automotive fuel consumption and emissions is well known. Therefore, vehicles are being developed that reduce or completely eliminate reliance on internal combustion engines. Electrified vehicles are one type of vehicle being developed for this purpose. In general, electrified vehicles differ from conventional motor vehicles because they are selectively driven by battery powered electric machines. Conventional motor vehicles, by contrast, rely exclusively on the internal combustion engine to propel the vehicle. A high voltage traction battery pack typically powers an electric machine and other electrical loads of an electrified vehicle. The traction battery pack includes a plurality of battery cells and various other battery internal components that are housed inside an outer enclosure assembly for supporting the electric propulsion of the vehicle.

### SUMMARY

In some aspects, the techniques described herein relate to a thermal management system for a vehicle, including: a primary circuit through which a refrigerant flows, the primary circuit including an evaporator and a condenser; a secondary circuit through which a coolant flows; a pump to drive the flow of coolant in the secondary circuit; and a plurality of control valves to regulate the flow of coolant in the secondary circuit, the control valves being activated by a control device to switch flow connections between within the secondary circuit; wherein at least one control valve is a multi-way valve having multiple openings, the connections between the openings established by a slide arranged to rotate within the valve.

In some aspects, the techniques described herein relate to a thermal management system, wherein the plurality of control valves includes no more than six control valves.

In some aspects, the techniques described herein relate to a thermal management system, wherein four of the control valves are five-way valves and two of the control valves are three-way valves.

In some aspects, the techniques described herein relate to a thermal management system, wherein each five-way valve has five openings.

In some aspects, the techniques described herein relate to a thermal management system, wherein the slide, when rotated through 360°, enables 12 different switching modes of each of the five-way valves.

In some aspects, the techniques described herein relate to a thermal management system, wherein the slide is configured to rotate through an angle of 120°, enabling five different switching modes of the five-way valve.

In some aspects, the techniques described herein relate to a thermal management system, further including a second primary circuit.

In some aspects, the techniques described herein relate to a thermal management system, wherein the coolant is a water-glycol mixture.

In some aspects, the techniques described herein relate to a thermal management system, wherein the primary circuit includes a compressor and a throttle to regulate refrigerant flow.

In some aspects, the techniques described herein relate to a thermal management system, further including a temperature-dependent directional valve configured to direct coolant based on a temperature threshold.

In some aspects, the techniques described herein relate to a thermal management system, wherein the control valves are configured to enable a secondary mode when the primary circuit is not operating according to normal operating conditions.

In some aspects, the techniques described herein relate to a thermal management system, further including an expansion tank connected to the secondary circuit to manage coolant volume changes.

In some aspects, the techniques described herein relate to an electrified vehicle including: a battery pack; a vehicle interior; an electronic component; a thermal management system configured to thermally manage the battery pack, the vehicle interior, and the electronic component, the thermal management system including: a primary circuit through which a refrigerant flows, the primary circuit including an evaporator and a condenser; a secondary circuit through which a coolant flows; a pump to drive the flow of coolant in the secondary circuit; and a plurality of control valves to regulate the flow of coolant in the secondary circuit, the control valves being activated by a control device to switch flow connections between within the secondary circuit; wherein at least one control valve is a multi-way valve having multiple openings, the connections between the openings established by a slide arranged to rotate within the valve.

In some aspects, the techniques described herein relate to an electrified vehicle, wherein the thermal management system is configured to prioritize heating of the battery pack over the vehicle interior when coolant temperature is below a threshold.

In some aspects, the techniques described herein relate to an electrified vehicle, wherein the control valves are configured to enable a dehumidification mode.

In some aspects, the techniques described herein relate to a method, including: detecting temperatures of a battery pack, an electronic component, and a vehicle interior of an electrified vehicle, the electrified vehicle including a thermal management system having a primary circuit with a refrigerant, a secondary circuit with a coolant, a plurality of control valves, and a control device; determining thermal requirements for the battery pack, the electronic component, and the vehicle interior based on the detected temperatures; and generating control signals for the control valves based on the thermal requirements; and adjusting the control valves to direct coolant flow to thermally manage the battery pack, the electronic component, and the vehicle interior, wherein at least one of the control valves is a multi-way valve having multiple openings and a slide arranged to rotate within the valve.

In some aspects, the techniques described herein relate to a method, wherein the control valves include four five-way valves.

In some aspects, the techniques described herein relate to a method, wherein the four five-way valves are each switched to a particular switching mode based on the temperature of the battery pack.

In some aspects, the techniques described herein relate to a method, further including prioritizing cooling of the vehicle interior by directing coolant from multiple evaporators to a cabin cooling device.

In some aspects, the techniques described herein relate to a method, further including adjusting the control valves to utilize heat from the electronic component to heat the battery pack when an ambient temperature falls below a threshold.

### BRIEF DESCRIPTION OF THE DRAWINGS

FIG. 1 shows a circuit diagram of an embodiment of a thermal management system.

FIG. 2 shows an illustration of an embodiment of a five-way valve used in the system according to FIG. 1.

FIG. 3 shows a table showing the switching variants of the valve according to FIG. 2.

FIG. 4 shows an illustration of 12 switching variants of the valve according to FIG. 2.

FIG. 5 shows switching variants of an embodiment of a three-way valve used in the system according to FIG. 1.

FIG. 6 shows a flowchart of an embodiment of a method.

FIG. 7 shows a circuit diagram according to FIG. 1 in a first switching state.

FIG. 8 shows a circuit diagram according to FIG. 1 in a second switching state.

FIG. 9 shows a circuit diagram according to FIG. 1 in a third switching state.

FIG. 10 shows a circuit diagram according to FIG. 1 in a fourth switching state.

FIG. 11 shows a circuit diagram according to FIG. 1 in a fifth switching state.

FIG. 12 shows a circuit diagram according to FIG. 1 in a sixth switching state.

FIG. 13 shows a circuit diagram according to FIG. 1 in a seventh switching state.

FIG. 14 shows a circuit diagram according to FIG. 1 in an eighth switching state.

FIG. 15 shows a circuit diagram according to FIG. 1 in a ninth switching state.

### DETAILED DESCRIPTION

This disclosure relates to a thermal management system for an electrified vehicle and a corresponding method.

A first aspect of this disclosure relates to a thermal management system for an electrified vehicle. This disclosure is not limited to any particular type of electrified vehicle, and extends to battery electric vehicles (BEVs), hybrid electric vehicles (HEVs), plug-in hybrid electric vehicles (PHEVs), etc.

In the first aspect, the electrified vehicle has at least one primary circuit, through which refrigerant flows and which has at least one indirect evaporator and at least one indirect condenser, and also having a secondary circuit through which a liquid coolant flows, wherein it is possible to control the flow of liquid in the lines of the secondary circuit to at least one cabin cooling device, at least one cabin heater, at least one traction battery, at least one heat exchanging device and at least to components of power electronics, wherein at least one pump to drive the flow of liquid in the circuits, and at least a number of control valves and check valves to regulate the flow of liquid in the secondary circuit are arranged in the thermal management system, these being activated by a control device. In the lines of the thermal management system, a number of no more than six control valves is arranged, by means of which, in a combination of their different operating states, a flow connection can be switched between the components of the power electronics and the heat exchanging device and/or the traction battery, wherein at least one control valve is designed as a five-way valve having five openings, and the connections between the openings can be established by a slide, in different variants, which is arranged so as to rotate within the valve.

The thermal management system according to this disclosure advantageously enables the temperature, in particular of a traction battery in an electrified vehicle, to be controlled with a comparatively low number of control valves. In this document, the traction battery is also synonymously referred to as a battery. The system is in particular designed to conduct excess heat from the power electronics from the local cooling circuit to the battery cooling circuit. The system is less complex than conventional systems and is robust in operation.

In this document, control valves are valves, of which the opening and closing modes are set by activating a control device, in contrast to check valves, which function in a pressure-controlled manner and do not have to be actively activated.

The primary circuit may generate both cooling power and heating power. In this respect, the indirect condenser represents the “hot” side of the primary circuit, and the indirect evaporators (also referred to as “chillers”) represent the “cold” side of the primary circuit. The primary circuit is thus regarded as a constructional unit, which is also referred to as a “compact refrigerant system” since refrigerant flows therein. The secondary circuit, in which liquid coolant flows, is located outside this constructional unit in the thermal management system.

Preferably, in the system according to this disclosure, four control valves are designed as five-way valves and two control valves are designed as three-way valves. Particularly preferably, all five-way valves are designed in such a way that they have five openings, and the connections between the openings can be established by a slide, in different variants, which is arranged so as to rotate within the valve. The design and arrangement of the five-way valves in conjunction with the two standard three-way valves (⅔-way valves) enable all thermal modes of the thermal management system according to this disclosure to be set. In other words, the thermal modes are implemented by setting the control valves to specific switching states.

Preferably, the annular slide, when rotated through 360°, enables a total of 12 different switching modes of the five-way valve to be achieved. These switching modes are made possible by the specific design of the annular slide and a matching diameter of the five-way valve. The annular slide is designed not as a closed circular ring, but rather has cutouts which enable fluid connections to be achieved between two inlets or outlets. The inlets and outlets of the five-way valve are always fully open, thus advantageously achieving a small pressure drop. A five-way valve used in the system according to this disclosure may also be used in other systems for controlling a fluid medium.

Particularly preferably, the slide in the five-way valve used in the thermal management system according to this disclosure is set in such a way that it can move in a rotatable manner through an angle of 120°, wherein the setting enables five different switching modes of the five-way valve to be achieved. The setting further reduces the complexity of the system according to this disclosure.

In a further preferred embodiment, the thermal management system according to this disclosure has a first and a second primary circuit. This arrangement advantageously enables devices in the thermal management system to be cooled further in an effective manner.

A second aspect of this disclosure relates to a vehicle with a thermal management system according to this disclosure.

A third aspect of this disclosure relates to a method for controlling a thermal management system according to this disclosure. The method has the following steps: ascertaining the temperatures in devices of the vehicle, including the traction battery, components of the power electronics and vehicle interior; determining the requirements for cooling or heating the devices of the vehicle; sending a control command to the control valves; and switching the control valves so that the devices of the vehicle are heated or cooled as required.

Preferably, the four five-way control valves are each switched to five different switching modes in order to conduct liquid coolant to the devices.

In addition, it is preferable if the four control valves are each switched to a particular switching mode depending on the temperature of the traction battery, in order to heat or cool the battery, or to maintain its current temperature.

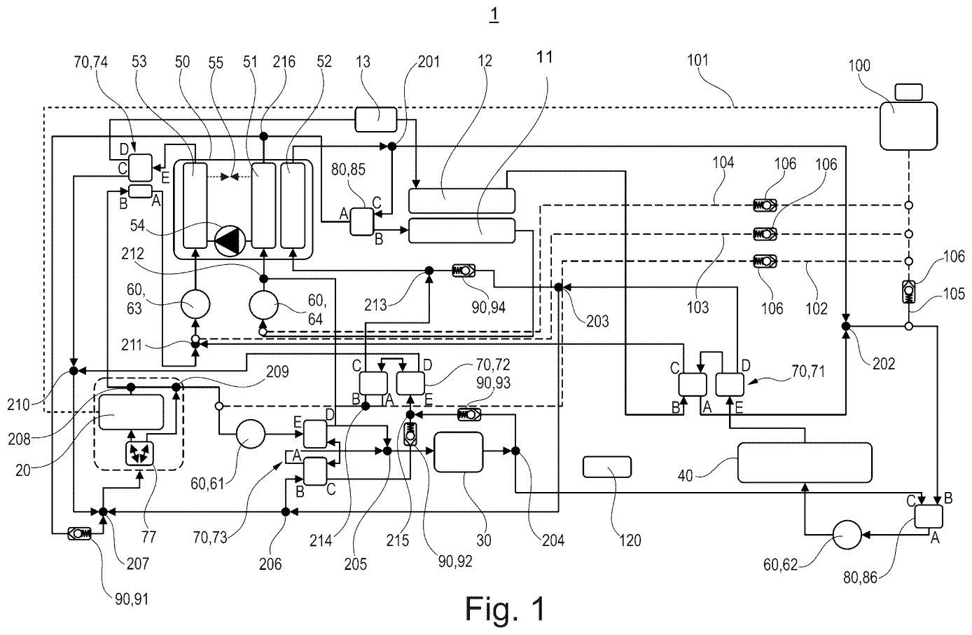

A circuit diagram of an embodiment of a thermal management system 1 according to this disclosure is illustrated in FIG. 1. The thermal management system 1 is arranged in an electrified vehicle.

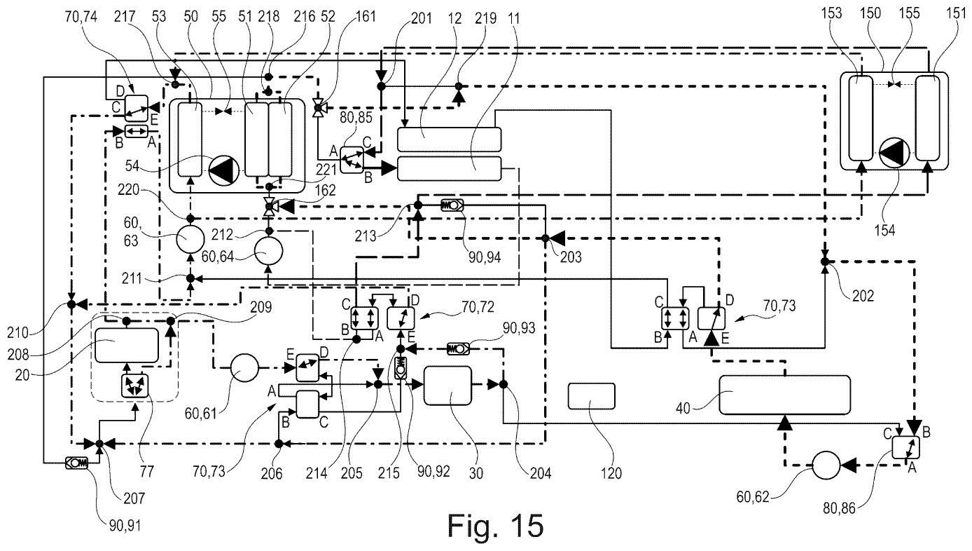

The thermal management system 1 has a primary circuit 50 and a secondary circuit; it is thus also referred to as a secondary circuit system. A refrigerant flows through the primary circuit 50. Arranged in the primary circuit 50 are a first and second chiller 51, 52 (also referred to as indirect evaporators) and an indirect condenser 53 (also referred to as an iCond). The first chiller 51 is connected to the indirect condenser 53 via a line with a compressor 54 and via a line with a throttle 55. The indirect condenser 53 is intended to provide warmer temperatures and the chillers 51 and 52 are intended to provide cooler temperatures. The primary circuit 50 is also referred to as a “compact refrigerant system”. In an embodiment with two compact refrigerant systems (FIG. 15), the primary circuit 50 described here may also be referred to as the first primary circuit 50.

The secondary circuit comprises a system of lines in which liquid coolant flows. The liquid coolant used is a water-glycol mixture or another expedient coolant familiar to a person skilled in the art. In the secondary circuit, the flow is supplied to a cooling device 11 for generating cooling power to cool the cabin (vehicle interior, passenger compartment), a heater 12 for generating heating power to heat the cabin with an upstream Positive Temperature Coefficient (PTC) heater 13, and a heat exchanger 20, components of the power electronics 30 and a traction battery 40. The secondary circuit is thus intended to transfer the cooling or heating power of the primary circuit to the drive components of the vehicle and also to release heat to the vehicle interior and the surroundings of the vehicle. The traction battery 40 may be referred to as a battery.

Four pumps 60 are arranged in the thermal management system 1 to generate a flow. A first pump 61 is arranged downstream of the heat exchanger 20. A second pump 62 is arranged upstream of the battery 40. A third pump 63 is arranged upstream of the indirect condenser 53. A fourth pump 64 is arranged upstream of the first chiller 51.

In the thermal management system 1, six control valves are arranged, specifically four five-way valves 70 and two three-way valves 80, which allow the flow of the coolant to be set for all relevant modes for cooling or heating up, in particular, the vehicle interior (not shown), the components of the power electronics 30, and the battery 40. A first control valve 71 is arranged downstream of the battery 40. A second control valve 72 is arranged downstream of the components of the power electronics 30, so that it is located between the components of the power electronics 30 and the second chiller 52. A third control valve 73 is arranged downstream of the heat exchanger 20, so that it is located between the heat exchanger 20 and the components of the power electronics 30. A fourth control valve 74 is arranged downstream of the indirect condenser 53 so that, depending on the switching configuration, it allows a flow to the heater 12 or to the heat exchanger 20. In addition, the fourth control valve 74 allows a flow from the heat exchanger 20 to the indirect condenser 53.

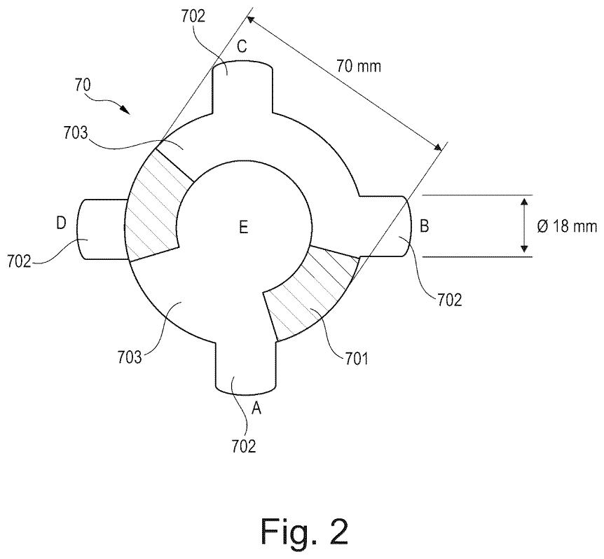

The control valves 71, 72, 73, 74 are each designed as five-way valves 70 in a design according to FIG. 2. The five-way valve 70 has an annular slide 701 which is arranged in a rotatable manner. The slide 701 can be rotated through an angle of 360°. A total of 12 different positions are possible, in each of which a specific combination of fluid paths through the valve 70 can be set. The diameter of the five-way valve 70 is 70 mm in one example. The five-way valve 70 has five openings 702, which are denoted by the letters A, B, C, D, and E. The openings 702, which act as inlets and outlets, are open in every mode; the openings 702 are connected by means of the annular slide 701 to provide flow paths. The diameter of the openings 702 may be 18 mm. The annular slide 701 has two cutouts 703 of such a size that at least one cutout 703 can fluidically connect two openings 702.

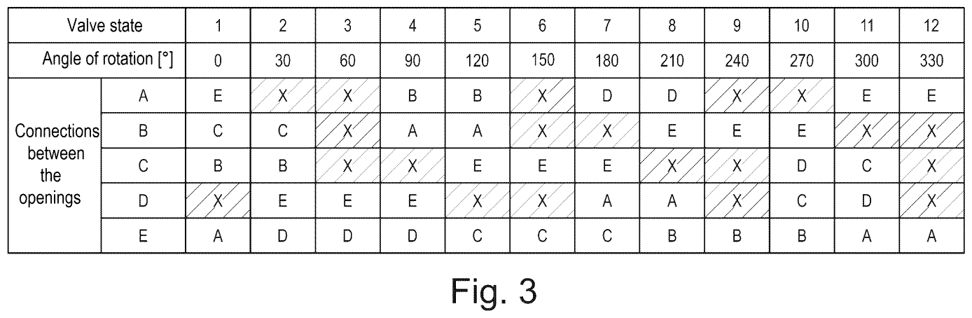

The table in FIG. 3 shows the possible settings of the five-way valve 70. The top row of the table contains the state numbers. The second row from the top sets out the angles of rotation of the annular slide. The bottom five rows set out the connections between the openings A, B, C, D, and E, corresponding to the state. The second column shows the said openings, and the further columns, which correspond to a respective state, show which openings are connected to the openings in the second column. X means that the opening in the second column is closed. The first five switching states 1, 2, 3, 4, and 5 are used for the operation of the five-way valves 70 in the thermal management system 1 according to FIG. 1.

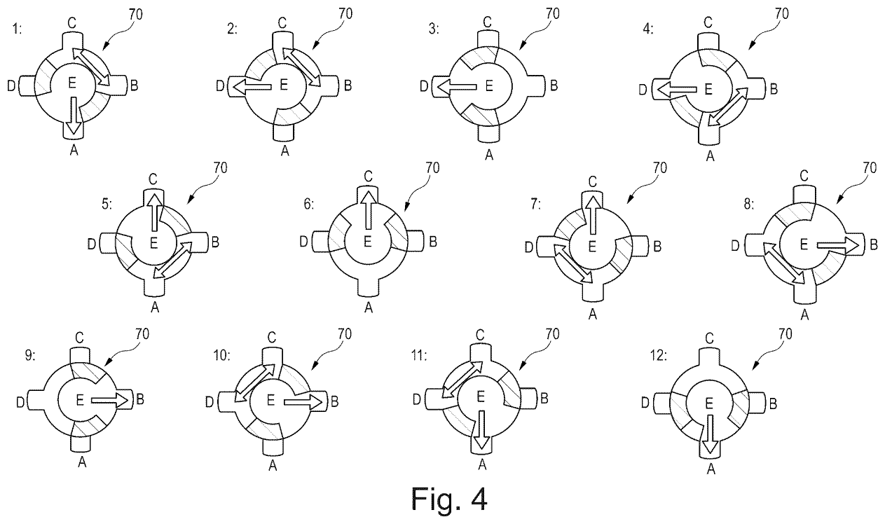

FIG. 4 schematically illustrates the 12 switching states of the five-way valve 70 as shown in FIG. 2 in accordance with the table in FIG. 3. In state 1, the annular slide 701 is at an angle of rotation of 0°. There is a connection in each case between the openings EA and BC; an arrow in one direction means that a flow in one direction is intended here, and an arrow in both directions means that a flow in both directions is intended. Opening D is closed.

In state 2, the annular slide 701 is at an angle of rotation of 30°. There is a connection in each case between the openings ED and BC. Opening A is closed. State 2 is provided as an example of the possibility of using the five-way valve 70 as a four-way valve.

In state 3, the annular slide 701 is at an angle of rotation of 60°. There is a connection between the openings ED. The openings A, B, and C are closed.

In state 4, the annular slide 701 is at an angle of rotation of 90°. There is a connection in each case between the openings ED and AB. Opening C is closed.

In state 5, the annular slide 701 is at an angle of rotation of 120°. There is a connection in each case between the openings EC and AB. Opening D is closed.

In state 6, the annular slide 701 is at an angle of rotation of 150°. There is a connection in each case between the openings EC. Openings A, B, and D are closed.

In state 7, the annular slide 701 is at an angle of rotation of 180°. There is a connection in each case between the openings EC and AD. Opening B is closed.

In state 8, the annular slide 701 is at an angle of rotation of 210°. There is a connection in each case between the openings EB and AD. Opening C is closed.

In state 9, the annular slide 701 is at an angle of rotation of 240°. There is a connection between the openings EB. The openings A, C, and C are closed.

In state 10, the annular slide 701 is at an angle of rotation of 270°. There is a connection in each case between the openings EB and CD. Opening A is closed.

In the 11th state, the annular slide 701 is at an angle of rotation of 300°. There is a connection in each case between the openings EA and CD. Opening B is closed.

In 12th state, the annular slide 701 is at an angle of rotation of 330°. There is a connection between the openings EA. The openings B, C, and D are closed.

A fifth and a sixth control valve 85, 86 are designed as three-way valves 80. The fifth control valve 85 is arranged upstream of the cooling device 11. Depending on the switching configuration, the fifth control valve 85 enables a fluid connection to be achieved between the first and/or second chiller 51, 52 to the cooling device 11, to the battery 40, or simultaneously to both the cooling device 11 and the battery 40.

The sixth control valve 86 is arranged upstream of the battery 40. Depending on the switching configuration of the flow paths, it may also be considered downstream of the components of the power electronics 30 or the second chiller 52.

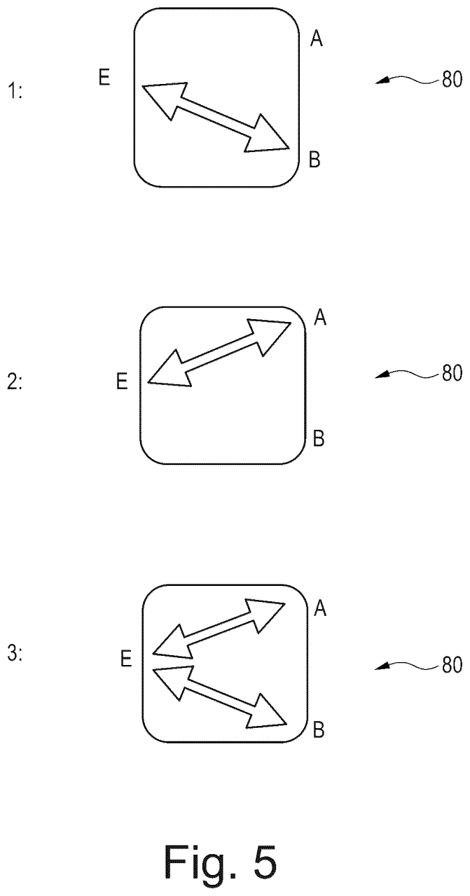

The switching states of the three-way valve 80 are illustrated in FIG. 5. The three-way valve 80 has three openings, specifically A, B, and E. There is a connection in state 1 between EB, wherein A is closed; in state 2 between EA, wherein B is closed; and in state 3 between EA and EB.

Furthermore, in FIG. 1, a temperature-dependent directional valve 77 is arranged upstream of the heat exchanger 20. In this arrangement, depending on a temperature threshold value, coolant is conducted through the heat exchanger 20 if the threshold value is reached, and is conducted past the heat exchanger 20 if the threshold value is not reached. Depending on the switching configuration of the flow paths, lines from the primary circuit 50, from the components of the power electronics 30, or from the battery 40 can be switched.

In the thermal management system 1 according to FIG. 1, the lines are connected at nodes 201-216, so that they form branches and orifices at these points.

A series of check valves 90 is arranged in the thermal management system 1. A first check valve 91 is arranged upstream of the node 207. A second check valve 92 is arranged downstream of the node 205 and upstream of the node 215 between the third control valve 73 and the second control valve 72. A third check valve 93 is arranged downstream of the components of the power electronics 30 between the nodes 204 and 215. A fourth check valve 94 is arranged upstream of the second chiller 52.

The heat exchanger 20 is connected to an expansion tank 100 via a first expansion line 101. The expansion tank 100 is connected to the lines of the circuits of the thermal management system 1, specifically upstream of the first pump 61 via a second expansion line 102, upstream of the third pump 63 via a third expansion line 103, upstream of the fourth pump via a fourth expansion line 104, and upstream of the sixth control valve 86 via a fifth expansion line 105. An expansion line check valve 106 is arranged in each of the expansion lines 102, 103, 104 and 105.

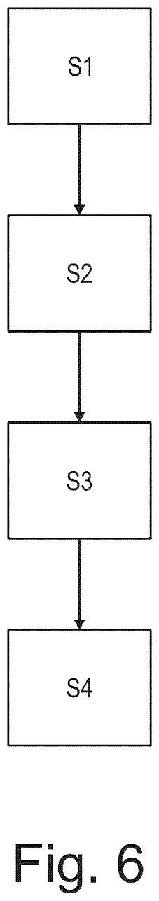

In a method for controlling a thermal management system 1 according to this disclosure as shown in FIG. 6, in a first step S1, the temperatures in devices of the vehicle, including the traction battery 40, components of the power electronics 30, and vehicle interior (not shown), are detected. In this process, the temperatures are detected by appropriate sensors and transmitted to a control device 120. In particular, in step S1, the temperature of the traction battery 40 is detected.

In a second step S2, the control device 120 ascertains the requirements for cooling or heating the devices of the vehicle. If the temperature is higher than a prescribed standard value, it is determined that cooling is required. If the temperature is lower than a prescribed standard value, it is determined that heating is required. The standard values may also be set as threshold values. If the temperature corresponds to the prescribed standard value, it is not necessary to change the temperature.

In a third step S3, the control device 120 sends control commands to the control valves 70 and check valves 90 in the thermal management system 1, which are set in a fourth step S4 in such a way that the coolant heats or cools the devices of the vehicle as required.

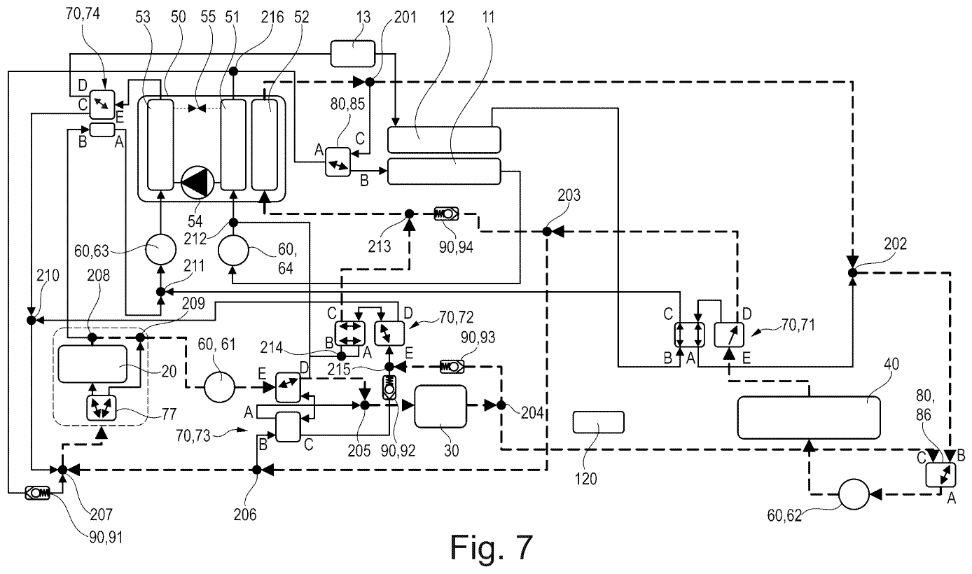

With reference to FIG. 7-15, the following describes nine different variants of settings for the control valves 71, 72, 73, 74, 85 and 86, and describes how the flow in the thermal management system 1 according to FIG. 1 is controlled in accordance with the heating or cooling required.

In FIG. 7, a first switching mode of the thermal management system 1 is illustrated, this switching mode representing a secondary mode in the event that the primary circuit 50 is not operating according to normal operating conditions. In this case, the components of the power electronics 30 and the battery 40 are cooled via the heat exchanger 20. In this process, the stream of coolant is switched from the battery 40 to the heat exchanger 20, from there to the components of the power electronics 30, and from there via the second chiller 52 to the battery 40 in the form of a circuit (indicated with a dashed line). The first and second pumps 61, 63 are switched on to drive the flow in the system. The five-way valves 70 are set to the following states according to FIG. 4: first control valve 71 to state 2, second control valve 72 to state 5, third control valve 73 to state 3 and fourth control valve 74 to state 3. The three-way valves 80 are set to the following states according to FIG. 5: fifth control valve 85 to state 1 and sixth control valve 86 to state 1.

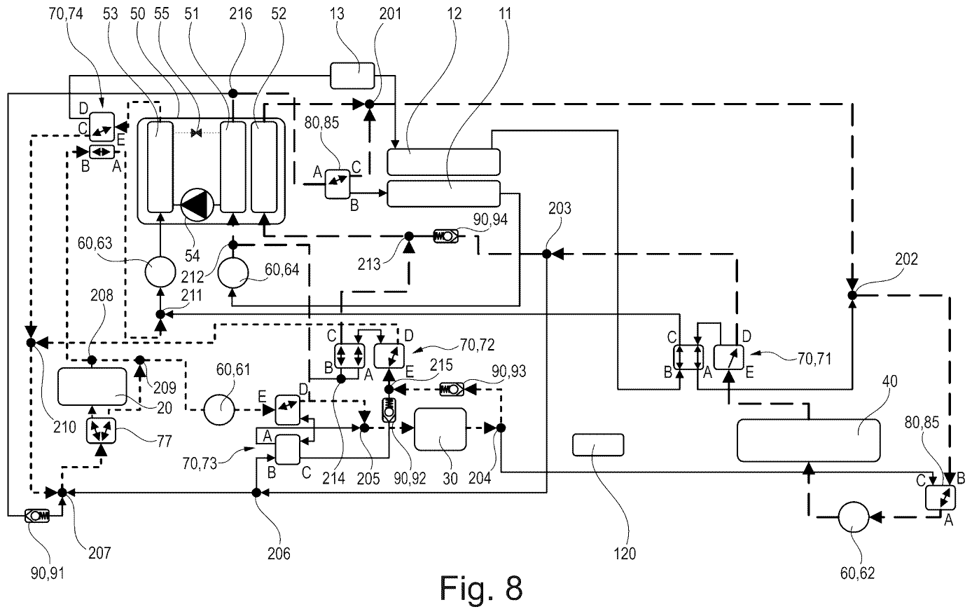

A second switching mode of the thermal management system 1 is illustrated in FIG. 8. In this mode, cooling of the traction battery 40 is required. Both chillers 51, 52 are used for this purpose and the vehicle interior is not cooled. The components of the power electronics 30 are cooled by the heat exchanger 20. For this purpose, a first sub-circuit (indicated with a dashed line) via the battery 40 and the chillers 51, 52 is closed, and a second sub-circuit (indicated with a dotted line) via the components of the power electronics 30, the indirect condenser 53 and the heat exchanger 20 is closed. The first, second and third pumps 61, 62, 63 are switched on to drive the flow in the system. The five-way valves 70 are set to the following states according to FIG. 4: first control valve 71 to state 2, second control valve 72 to state 2, third control valve 73 to state 3 and fourth control valve 74 to state 5. The three-way valves 80 are set to the following states according to FIG. 5: fifth control valve 85 to state 2 and sixth control valve 86 to state 1.

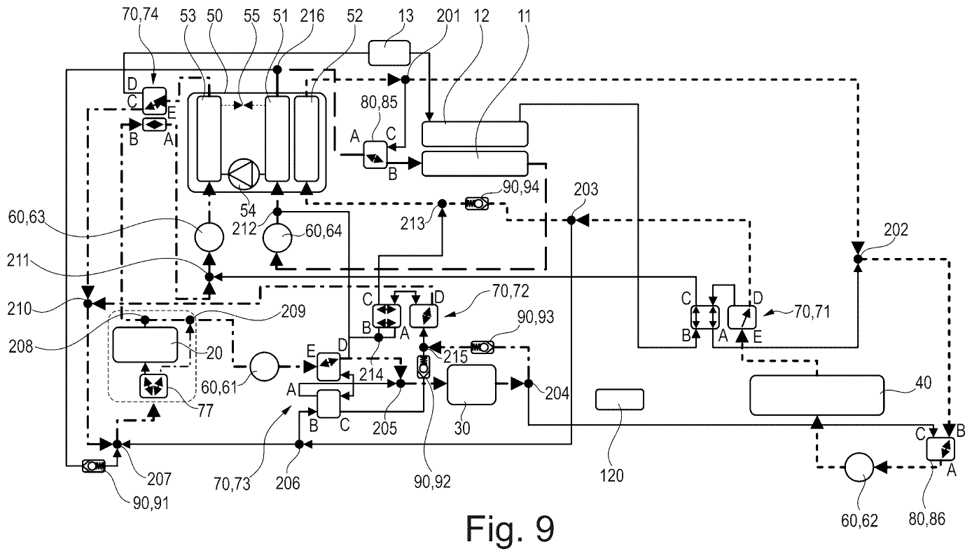

A third switching mode of the thermal management system 1 is illustrated in FIG. 9. In this mode, the traction battery 40 and the vehicle interior are each cooled independently. In this process, the vehicle interior is cooled via the first chiller 51 and the traction battery 40 is cooled via the second chiller 52. In addition, the components of the power electronics 30 are cooled by the heat exchanger 20. In a first sub-circuit (indicated with a dashed line), coolant is conducted from the first chiller 51 to the cooling device 11 and from there back to the first chiller 51 again. In a second sub-circuit (indicated with a dotted line), coolant is conducted from the second chiller 52 to the battery 40 and back to the second chiller 52 again. To cool the components of the power electronics 30 using the heat exchanger 20, coolant is conducted in a third sub-circuit (indicated with a dash-dotted line) from the heat exchanger 20 to the components of the power electronics 30 and to the indirect condenser 53, and from there in each case back to the heat exchanger 20. The first, second, third and fourth pumps 61, 62, 63, 64 are switched on to drive the flow in the system. The five-way valves 70 are set to the following states according to FIG. 4: first control valve 71 to state 1, second control valve 72 to state 4, third control valve 73 to state 3 and fourth control valve 74 to state 5. The three-way valves 80 are set to the following states according to FIG. 5: fifth control valve 85 to state 1 and sixth control valve 86 to state 1.

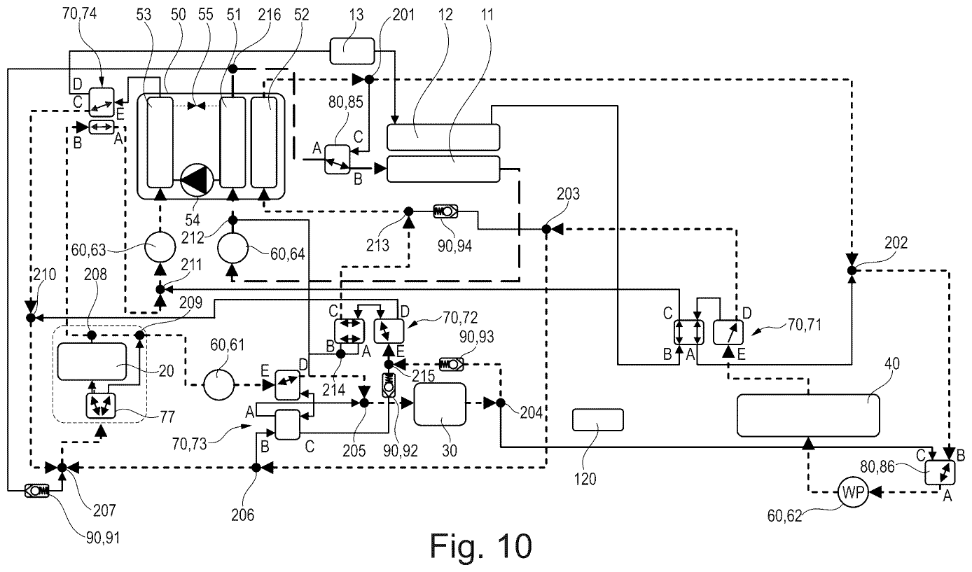

A fourth switching mode of the thermal management system 1 is illustrated in FIG. 10. In this mode, the vehicle interior is cooled by the first chiller 51 and the traction battery 40 is subject to mild cooling, wherein, here, depending on the cooling required, it is possible to swap between cooling by the second chiller 52 and cooling by the heat exchanger 20. In addition, the components of the power electronics 30 are likewise cooled by the second chiller 52 and the heat exchanger 20. The passive cooling of the traction battery 40 via the heat exchanger 20 allows energy to be saved and the range thereby increased. If the second chiller 52 is to be used (active cooling), it is used only briefly in this mode for energy-saving purposes, in order to enable a desired minor reduction to be achieved in the temperature of the traction battery 40. In a first sub-circuit (indicated with a dashed line), coolant is conducted from the first chiller 51 to the cooling device 11 and from there back to the first chiller 51 again. In a second sub-circuit (indicated with a dotted line), coolant is conducted from the second chiller 52 to the battery 40, and from there to the heat exchanger 20. From the heat exchanger 20, coolant is conducted to the components of the power electronics 30 and to the indirect condenser 53. From the indirect condenser 53, coolant is conducted back to the heat exchanger 20. From the components of the power electronics 30, coolant is conducted back to the second chiller 52. The first, second, third and fourth pumps 61, 62, 63, 64 are switched on to drive the flow in the system. The five-way valves 70 are set to the following states according to FIG. 4: first control valve 71 to state 2, second control valve 72 to state 5, third control valve 73 to state 3 and fourth control valve 74 to state 5. The three-way valves 80 are set to the following states according to FIG. 5: fifth control valve 85 to state 1 and sixth control valve 86 to state 1.

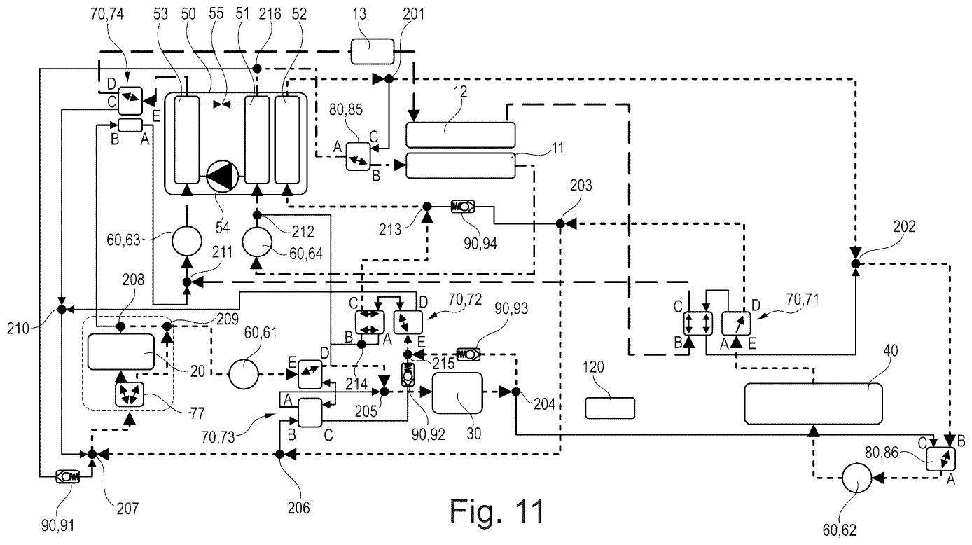

A fifth switching mode of the thermal management system 1 is illustrated in FIG. 11. In this mode, the vehicle interior is heated and dehumidified, and the traction battery 40 is cooled. Here, in a first dehumidification mode, either warm and cold coolant can be conducted to an integrated heating and air conditioning housing having an interior cooler, interior heater, and a fan, and the battery can be passively cooled, or, in a second dehumidification mode, either warm and cold coolant can be conducted to the housing and the battery can be heated by conducting the coolant past the heat exchanger 20, or in the heat recovery mode, heat from the components of the power electronics 30 and the traction battery 40 can be utilized to heat the vehicle interior (wherein coolant is conducted past a low temperature radiator (LTR)). In a first sub-circuit (indicated with a dashed line), coolant is conducted from the heater 13 to the heater 12, and from there to the indirect condenser 53, and from there back to the heater 13. In addition, in a second sub-circuit (indicated with a dotted line), the battery 40 and the components of the power electronics 30 are cooled. For this purpose, coolant is conducted from the second chiller 52 to the battery 40, from there to the heat exchanger 20, from there to the components of the power electronics 30, and from there back to the second chiller 52 again. In a third sub-circuit (indicated with a dash-dotted line), coolant is conducted from the first chiller 51 to the cooling device 11 and back to the first chiller 51 again. The first, second, third and fourth pumps 61, 62, 63, 64 are switched on to drive the flow in the system. The five-way valves 70 are set to the following states according to FIG. 4: first control valve 71 to state 2, second control valve 72 to state 5, third control valve 73 to state 3 and fourth control valve 74 to state 3. The three-way valves 80 are set to the following states according to FIG. 5: fifth control valve 85 to state 1 and sixth control valve 86 to state 1.

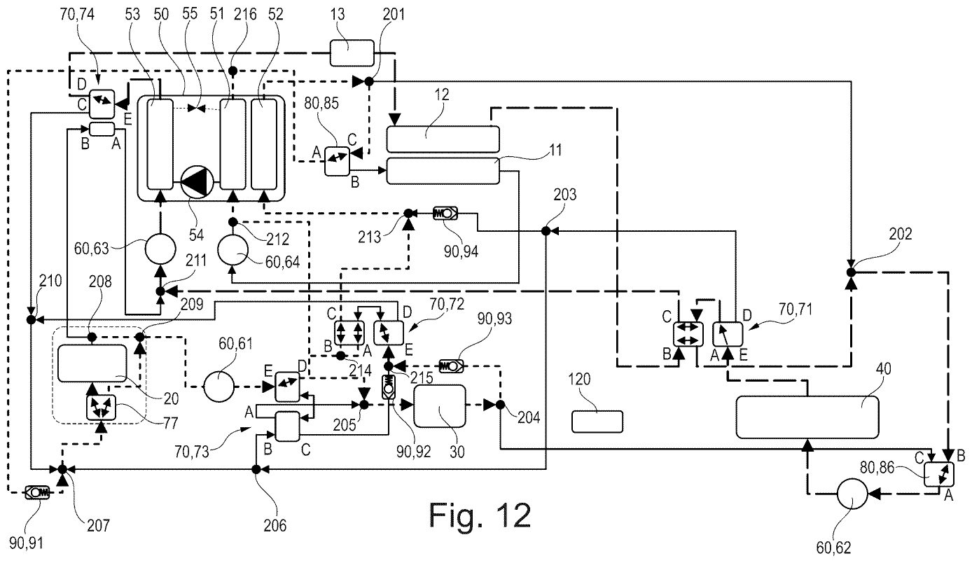

A sixth switching mode of the thermal management system 1 is illustrated in FIG. 12. In this mode, the traction battery 40 and the vehicle interior are to be heated rapidly. In this case, heating up the traction battery 40 takes priority; if the temperature of the coolant is not sufficiently high, the cabin heater 12 is switched off and supply to the traction battery 40 is prioritized. This mode is set in particular when the corresponding vehicle begins operation. In a first sub-circuit (indicated with a dashed line), coolant is conducted from the indirect condenser 53 via the heater 13 to the heater 12, from there to the battery 40, and from there back to the indirect condenser 53. In a second sub-circuit (indicated with a dotted line), coolant is conducted from the heat exchanger 20 through the region of the components of the power electronics 30, from there to the first and second chillers 51, 52, and back to the heat exchanger 20 again. The first, second and third pumps 61, 62, 63 are switched on to drive the flow in the system. The five-way valves 70 are set to the following states according to FIG. 4: first control valve 71 to state 5, second control valve 72 to state 1, third control valve 73 to state 3 and fourth control valve 74 to state 3. The three-way valves 80 are set to the following states according to FIG. 5: fifth control valve 85 to state 2 and sixth control valve 86 to state 1.

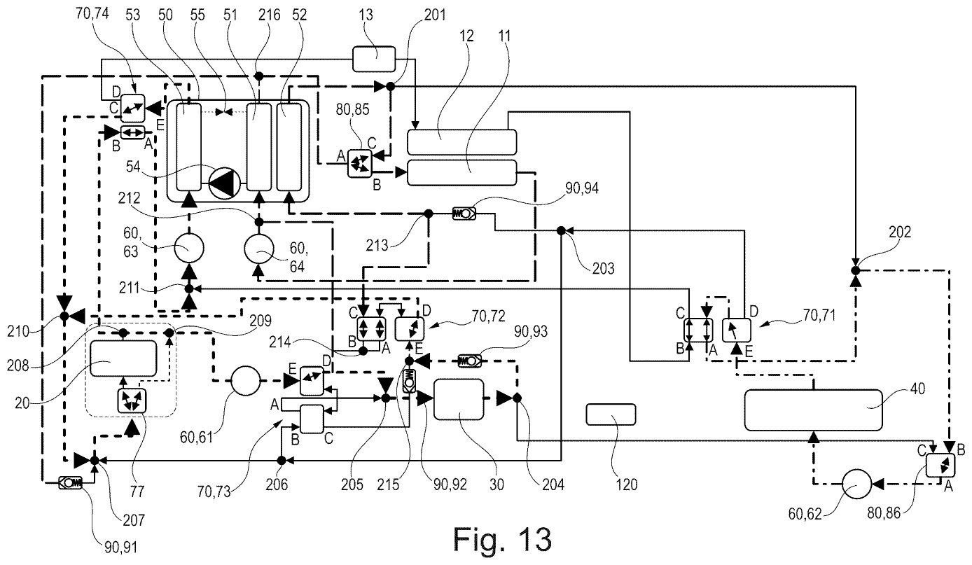

A seventh switching mode of the thermal management system 1 is illustrated in FIG. 13. In this mode, the vehicle interior is cooled as a matter of priority by the two chillers 51, 52. In a first sub-circuit, coolant is conducted from the two chillers 51, 52 to the cooling device 11, and from there back to the two chillers 51, 52 again (indicated with a dashed line). In addition, the components of the power electronics 30 are cooled by the heat exchanger 20. In a second sub-circuit (indicated with a dotted line) coolant in the heat exchanger 20 is conducted to the components of the power electronics 30 and to the indirect condenser 53 and from there in each case back to the heat exchanger 20. In the region of the battery 40, coolant circulates in a third sub-circuit (indicated with a dash-dotted line). The first, second, third and fourth pumps 61, 62, 63, 64 are switched on to drive the flow in the system. The five-way valves 70 are set to the following states according to FIG. 4: first control valve 71 to state 1, second control valve 72 to state 2, third control valve 73 to state 3 and fourth control valve 74 to state 5. The three-way valves 80 are set to the following states according to FIG. 5: fifth control valve 85 to state 3 and sixth control valve 86 to state 1.

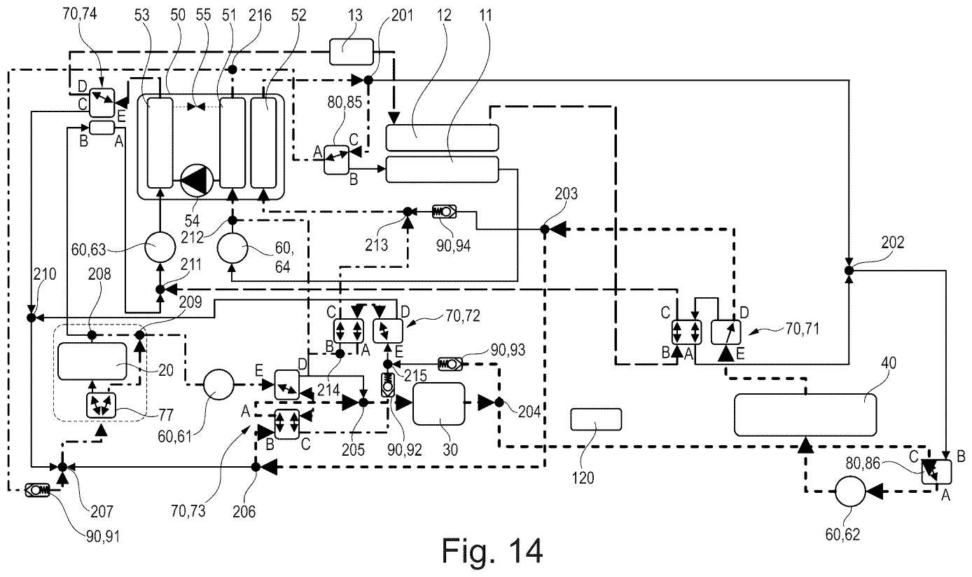

An eighth switching mode of the thermal management system 1 is illustrated in FIG. 14. In this mode, the vehicle interior is heated by the heater 12 by means of the heater 13 and the indirect condenser 53. Independently of this, the battery 40 is heated by utilizing heat from the components of the power electronics 30. This switching configuration may be particularly advantageous at low ambient temperatures. In a first sub-circuit (indicated with a dashed line), coolant is conducted from the indirect condenser to the heater 13, from there to the heater 12, and from there to the indirect condenser again. In a second sub-circuit (indicated with a dotted line), coolant is conducted from the components of the power electronics 30 to the battery 40 and back. In a third sub-circuit (indicated with a dash-dotted line), coolant is conducted from the heat exchanger 20 to the first and second chillers 51, 52 and back to the heat exchanger 20 again. The first, second and third pumps 61, 62, 63 are switched on to drive the flow in the system. The five-way valves 70 are set to the following states according to FIG. 4: first control valve 71 to state 2, second control valve 72 to state 1, third control valve 73 to state 5 and fourth control valve 74 to state 3. The three-way valves 80 are set to the following states according to FIG. 5: fifth control valve 85 to state 2 and sixth control valve 86 to state 2.

In FIG. 15, a further embodiment according to the illustration in FIG. 11 is in comparison with FIG. 1 the thermal management system 1 according to this disclosure has a second primary circuit 150. A refrigerant flows through the second primary circuit 150. A third chiller 151 and a second indirect condenser 153 are arranged in the second primary circuit 150. The third chiller 151 is connected to the second indirect condenser 153 via a line with a second compressor 154 and also via a line with a second throttle 155. In comparison with FIG. 1, no additional control valves are necessary to integrate the second primary circuit 150 into the thermal management system 1. The thermal management system 1 according to FIG. 15 has additional nodes 217 to 221. The third chiller 151 is connected to the secondary circuit of the thermal management system 1 via the nodes 201 and 213. The second indirect condenser 153 is connected to the secondary circuit of the thermal management system 1 via the nodes 217 and 220.

The thermal management system 1 according to FIG. 15 enables a ninth switching mode to be achieved for cooling the vehicle interior and battery 40 independently. The vehicle interior is cooled by the third chiller 151, the battery 40 is cooled by the first and second chillers 51, 52, and the components of the power electronics 30 are cooled by the heat exchanger 20. In a first sub-circuit (indicated with a dashed line), coolant is conducted from the third chiller 151 to the cooling device 11, and from there back to the third chiller 151. In a second sub-circuit (indicated with a dotted line), coolant is conducted from the first and second chiller 51, 52 to the battery 40, and from there back to the first and second chiller 51, 52 again. In a third sub-circuit (indicated with a dash-dotted line), coolant is conducted from the heat exchanger 20 to the components of the power electronics 30, and from there back to the heat exchanger 20. In addition, coolant is conducted from the heat exchanging device to the first indirect condenser 53 and to the second indirect condenser 153. In this case, coolant is conducted at the node 209 to the components of the power electronics 30 and the indirect condensers 53, 153, and at the node 220 also to the first indirect condenser 53 and second indirect condenser 153. The first, second, third and fourth pumps 61, 62, 63, 64 are switched on to drive the flow in the system. The five-way valves 70 are set to the following states according to FIG. 4: first control valve 71 to state 2, second control valve 72 to state 2, third control valve 73 to state 3 and fourth control valve 74 to state 5. The three-way valves 80 are set to the following states according to FIG. 5: fifth control valve 85 to state 3 and sixth control valve 86 to state 1.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A thermal management system for a vehicle, comprising:
a primary circuit through which a refrigerant flows, the primary circuit including an evaporator and a condenser;
a secondary circuit through which a coolant flows;
a pump to drive the flow of coolant in the secondary circuit; and
a plurality of control valves to regulate the flow of coolant in the secondary circuit, the control valves being activated by a control device to switch flow connections between within the secondary circuit;
wherein at least one control valve is a multi-way valve having multiple openings, the connections between the openings established by a slide arranged to rotate within the valve.

2. The thermal management system of claim 1, wherein the plurality of control valves includes no more than six control valves.

3. The thermal management system of claim 2, wherein four of the control valves are five-way valves and two of the control valves are three-way valves.

4. The thermal management system of claim 3, wherein each five-way valve has five openings.

5. The thermal management system of claim 4, wherein the slide, when rotated through 360°, enables 12 different switching modes of each of the five-way valves.

6. The thermal management system of claim 4, wherein the slide is configured to rotate through an angle of 120°, enabling five different switching modes of the five-way valve.

7. The thermal management system of claim 1, further comprising a second primary circuit.

8. The thermal management system of claim 1, wherein the coolant is a water-glycol mixture.

9. The thermal management system of claim 1, wherein the primary circuit includes a compressor and a throttle to regulate refrigerant flow.

10. The thermal management system of claim 1, further comprising a temperature-dependent directional valve configured to direct coolant based on a temperature threshold.

11. The thermal management system of claim 1, wherein the control valves are configured to enable a secondary mode when the primary circuit is not operating according to normal operating conditions.

12. The thermal management system of claim 1, further comprising an expansion tank connected to the secondary circuit to manage coolant volume changes.

13. An electrified vehicle comprising:
a battery pack;
a vehicle interior;
an electronic component;
a thermal management system configured to thermally manage the battery pack, the vehicle interior, and the electronic component, the thermal management system including:
a primary circuit through which a refrigerant flows, the primary circuit including an evaporator and a condenser;
a secondary circuit through which a coolant flows;
a pump to drive the flow of coolant in the secondary circuit; and
a plurality of control valves to regulate the flow of coolant in the secondary circuit, the control valves being activated by a control device to switch flow connections between within the secondary circuit;
wherein at least one control valve is a multi-way valve having multiple openings, the connections between the openings established by a slide arranged to rotate within the valve.

14. The electrified vehicle of claim 13, wherein the thermal management system is configured to prioritize heating of the battery pack over the vehicle interior when coolant temperature is below a threshold.

15. The electrified vehicle of claim 13, wherein the control valves are configured to enable a dehumidification mode.

16. A method, comprising:
detecting temperatures of a battery pack, an electronic component, and a vehicle interior of an electrified vehicle, the electrified vehicle including a thermal management system having a primary circuit with a refrigerant, a secondary circuit with a coolant, a plurality of control valves, and a control device;
determining thermal requirements for the battery pack, the electronic component, and the vehicle interior based on the detected temperatures; and
generating control signals for the control valves based on the thermal requirements; and
adjusting the control valves to direct coolant flow to thermally manage the battery pack, the electronic component, and the vehicle interior, wherein at least one of the control valves is a multi-way valve having multiple openings and a slide arranged to rotate within the valve.

17. The method of claim 16, wherein the control valves include four five-way valves.

18. The method of claim 17, wherein the four five-way valves are each switched to a particular switching mode based on the temperature of the battery pack.

19. The method of claim 16, further comprising prioritizing cooling of the vehicle interior by directing coolant from multiple evaporators to a cabin cooling device.

20. The method of claim 16, further comprising adjusting the control valves to utilize heat from the electronic component to heat the battery pack when an ambient temperature falls below a threshold.
